(19) United States
(12) Patent Application Publication
(10) Pub. No.: US 2010/0089211 A1
(43) Pub. Date: Apr. 15, 2010

(54) ADJUSTABLE CUTTING TOOL

(76) Inventor: James Rebuck, Elwood, IN (US)

Correspondence Address: ICE MILLER LLP, ONE AMERICAN SQUARE, SUITE 3100, INDIANAPOLIS, IN, 46282-0200, US

(21) Appl. No.: 12/577,313

(22) Filed: Oct. 12, 2009

Related U.S. Application Data
(60) Provisional application No. 61/104,569, filed on Oct. 10, 2008.

(51) Int. Cl. B26D 3/00; B26D 1/00; B26D 1/14; B26D 7/04

(52) U.S. Cl. 83/54; 83/859; 83/471; 83/466

(57) ABSTRACT

Adjustable cutting tools and methods of cutting through the casing wall of a pipe using an adjustable cutting tool are disclosed. According to one embodiment of this disclosure, an adjustable cutting tool includes a frame, a drive system, and a cutting system. The frame is configured to secure the tool to the exterior surface of a pipe. The drive system is configured to move the tool across the surface of the pipe, and the cutting system is configured to cut into the surface and through the wall of the pipe. By combining the features of the frame, drive system, and cutting system, the adjustable cutting tool may cut a pipe as it moves along the surface of the pipe.

### CROSS REFERENCE TO RELATED APPLICATION

This application claims the benefit of and incorporates by reference herein the disclosure of U.S. Ser. No. 61/104,569, filed Oct. 10, 2008.

### BACKGROUND

In the pipeline industry, pipeline casings have been used to protect carrier pipes from external loads, such as from roadways, and other external factors. The use of pipeline casings have also provided for a less disruptive way of replacing or repairing a carrier pipe. For instance, a segment of carrier pipe can simply be pulled out of the casing without having to dig up areas around or near the segment of carrier pipe of interest, which could include a road or the like. In order to inspect and maintain carrier pipe, though, it is sometimes necessary to cut and remove pipe casing off from a carrier pipe.

Typically, pipe casings have been removed with the use of oxy-acetylene torches, which burn at high temperature. However, acetylene torches are expensive. Also, a host of environmental and bodily hazards are present when using oxy-acetylene torches. For example, the annular space between casings and carrier pipes are sometimes filled with wax. When oxy-acetylene torches are used, this wax can melt and potentially spoil the immediate environment. Also, casings and other pipes may have a factory applied coating that contains asbestos. The flame of the oxy-acetylene torch burns the coating, which causes asbestos particles to be released and become airborne. Obviously, this is a major health concern. Accordingly, it is desired to provide an improved tool for cutting pipes.

### SUMMARY

An aspect of the present disclosure comprises an adjustable cutting tool for cutting through the wall of a pipe. At least one embodiment of such a cutting tool comprises a frame having a plurality of members connected to form a shape with an open section, wherein the open section of the frame is configured to receive a pipe and wherein the plurality of members are configured to be adjusted relative to each other such that the cross-sectional area of the open section of the frame is variable. In an aspect of this embodiment, the frame may include four members that are connected to form a substantially square-diamond shape with an open section. The cutting tool further includes a drive system configured to be attached to the frame. In an aspect of this embodiment, the drive system may comprise one or more drive motors, one or more sets of wheels, and one or more drive chains that connect each drive motor to a set of wheels, wherein at least one wheel is configured to be rotated by the drive chain. In an aspect of this embodiment, the cutting tool further includes a cutting system comprising at least one cutting motor and at least one cutting blade. The at least one cutting motor may be configured to rotate the at least one cutting blade. Also, the at least one cutting blade may be configured to at least partially extend into the open section of the frame.

An aspect of the present disclosure comprises a method of cutting through the casing wall of a pipe using an adjustable cutting tool. At least one embodiment of such method includes the step of providing an adjustable cutting tool having a frame comprising a plurality of members configured to be connected to form a substantially square-diamond shape with an open section, wherein the open section of the frame is configured to receive a pipe and wherein the plurality of members are configured to be adjusted relative to each other such that the cross-sectional area of the open section of the frame is variable. The cutting tool further includes a drive system configured to be attached to the frame. In an aspect of this embodiment, the drive system may include a drive motor, a plurality of wheels, and a drive chain that connects the drive motor to the plurality of wheels, wherein the plurality of wheels are configured to be rotated by the drive chain. In an aspect of this embodiment, the cutting tool may also include a cutting system comprising at least one cutting motor and at least one cutting blade, wherein the at least one cutting motor is configured to rotate the at least one cutting blade. In an aspect of this embodiment, the method may also include the steps of assembling the frame of the tool around a pipe, activating the drive system and the cutting system of the tool, cutting the pipe using the at least one cutting blade of the cutting system of the tool, and moving the tool along the pipe using the drive system.

### BRIEF DESCRIPTION OF THE DRAWINGS

The features and advantages of this disclosure, and the manner of attaining them, will be more apparent and better understood by reference to the following descriptions of the disclosed method and apparatus, taken in conjunction with the accompanying drawings, wherein:

FIG. 1 shows a perspective view of an embodiment of the tool of the present disclosure;

FIG. 2a shows a perspective view of a member of the frame of FIG. 1;

FIG. 2b shows a perspective view of a bracing of FIG. 1;

FIG. 3 shows a perspective view of a portion of the frame and drive system of FIG. 1;

FIG. 4a shows an exploded perspective view of a first and second v-shaped frame with drive system and cutting system according to at least one embodiment of the present disclosure;

FIG. 4b shows a perspective view of the v-shaped frames with drive system and cutting system of FIG. 4a in position to be assembled on a pipe;

FIG. 4c shows a perspective view of the v-shaped frames with drive system and cutting system of FIG. 1 secured to a pipe; and

FIG. 5 shows a flow chart of the steps for cutting through the casing wall of a pipe according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

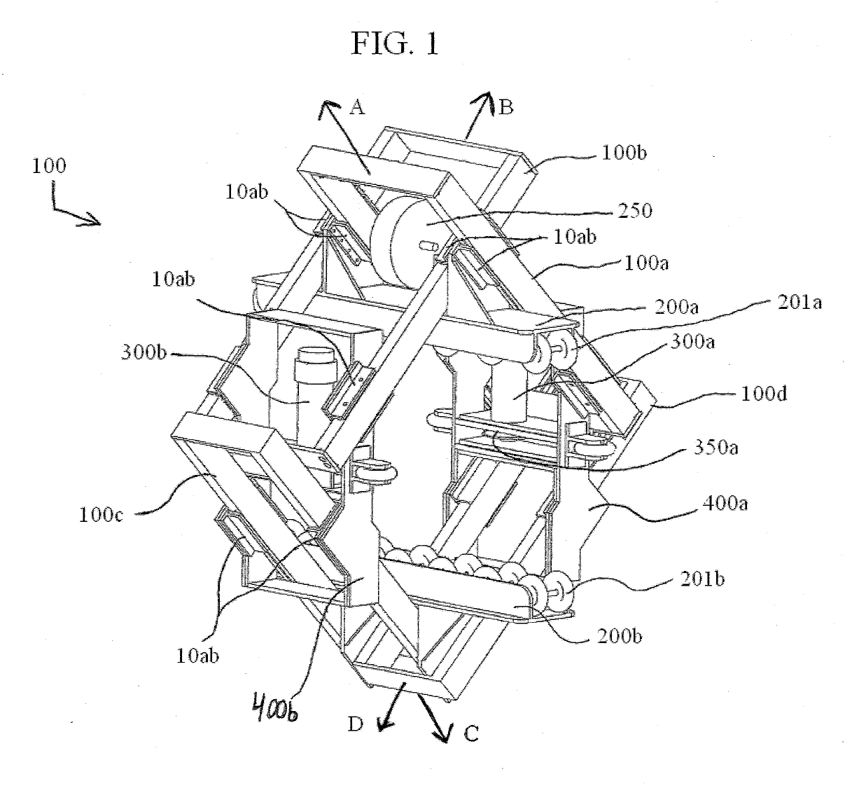

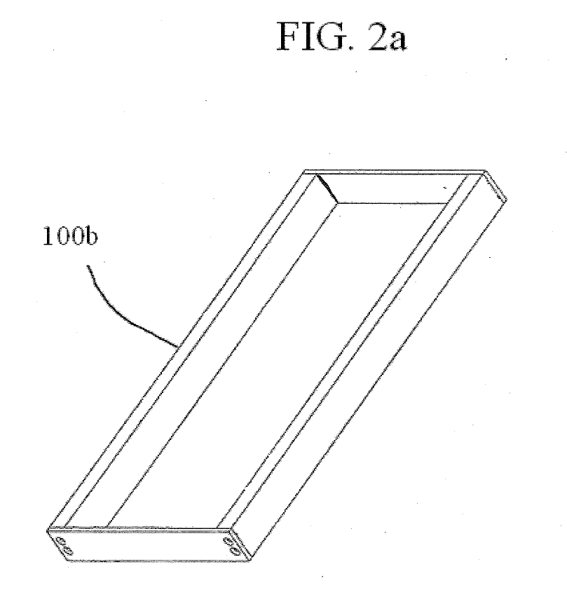

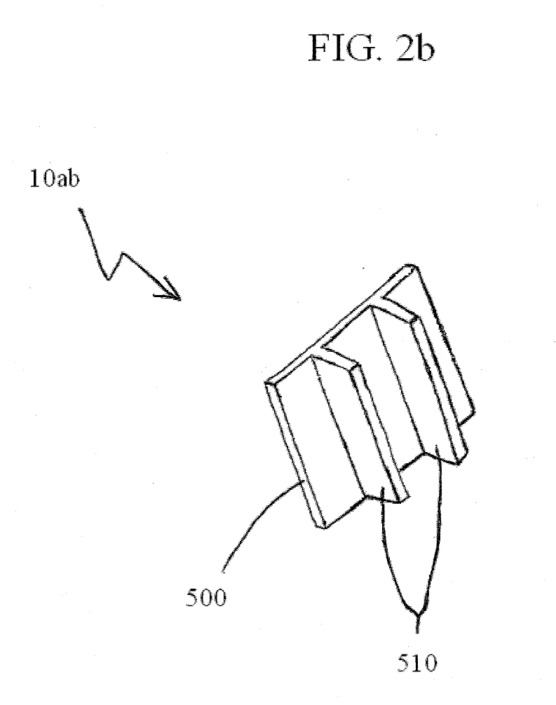

FIG. 1 shows an embodiment of the adjustable cutting tool 100 of the present disclosure. An adjustable cutting tool 100 of the present disclosure includes a frame, a drive system, and a cutting system. Along with the drive system, the frame is configured to secure the tool 100 to the exterior surface of a pipe such that, for example, the tool 100 may be suspended from the pipe above the ground. The frame may include a single, solid structure having a desired shape that can receive a pipe. Generally, though, a frame may include several members that can be secured to one another. As shown in FIG. 1, the frame may include four members 100a,100b,100c,100d that are each rectangular in shape with open sections. FIG. 2a shows an example of a member 100b of a frame that is rectangular in shape with an open section. Each member of a frame, such as the members 100a, 100c, and 100d in the frame shown in FIG. 1, may be the same shape as member 100b shown in FIG. 2a.

In FIG. 1, the four members 100a,100b,100c,100d are arranged and secured to each other to form a square-diamond shaped structure with an open section. Of course, the frame may include fewer or greater numbers of members and the members may have other shapes. Also, the members may be arranged in other geometrical shapes with an open section such as, for example, a triangle, pentagon, hexagon, octagon, and the like.

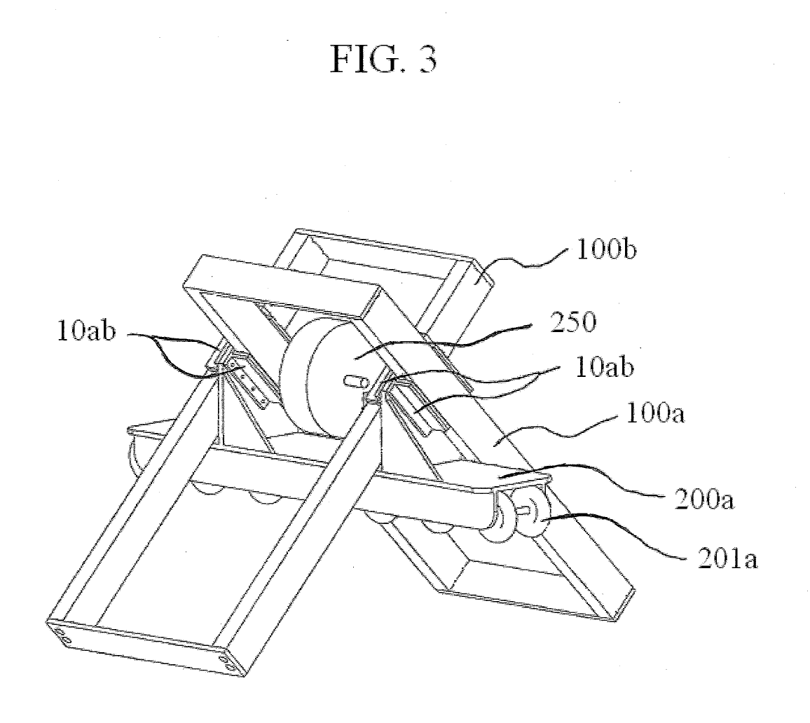

A member of the frame is typically secured to an adjacent member using fasteners and bracings 10ab but may be secured in other ways. As shown in FIG. 3, members 100a and 100b are secured to each other using one or more bracings 10ab. As shown in FIG. 2b, a bracing 10ab may include a substantially flat plate 500 with two segments 510 extending substantially perpendicular to one side of the plate 500. As shown in FIGS. 1 and 3, a bracing 10ab may receive a member 100a,100b,100c,100d between the two segments 510 of the bracing 10ab. The member 100a,100b,100c,100d may be secured to one or both of the segments 510 of the bracing 10ab, while the plate 500 of the bracing 10ab may be attached to other bracings 10ab, the frame, support structures (described below), and the like.

A tool 100 with multiple members is readily adaptable to different sizes of pipeline. By fastening members 100a,100b,100c,100d of the frame to bracings 10ab (or directly to each other) at various locations along the length of each member, the cross-sectional area of the open section of the frame may be varied. For members 100a,100b,100c,100d attached to each other using bracings 10ab and corresponding fasteners, the fasteners securing a member 100a,100b,100c,100d to the segments of bracing 10ab may be removed such that the member 100a,100b,100c,100d may be moved relative to the bracing 10ab. In FIG. 1, when the fasteners are removed from the bracings 10ab, each member 100a,100b,100c,100d may be adjusted relative to each other. For instance, member 100a may be moved in the direction shown by arrow A, member 100b may be moved in the direction shown by arrow B, member 100c may be moved in the direction shown by arrow C, and member 100d may be moved in the direction shown by arrow D. Moreover, the one or more segments 510 of a bracing 10ab may act as a guide for translating a member 100a,100b,100c,100d relative to a bracing 10ab. In other words, segments 510 of a bracing 10ab may guide the movement of a member 100a,100b,100c,100d such that it moves only along a line. For example, in FIG. 1, the segments 510 of the bracings 10ab that are attached to member 100a may guide the movement or adjustment of member 100a along the line defined by arrow A. By making the cross-sectional area of the open section of the frame smaller or larger, the tool 100 can accommodate a smaller or larger, respectively, diameter of pipe. In this way, the tool 100 may be secured to a range of pipeline diameters. In one exemplary embodiment, the tool 100 may be configured to accommodate pipeline diameters between eight inches and thirty-six inches. Of course, other embodiments of the tool 100 may be configured to accommodate other diameters of pipe. Generally, the frame of a tool 100 may substantially retain its shape (e.g., square diamond shape) as it is adjusted to accommodate various size pipes. It should be noted, though, that the frame may be configured to have different shapes for different sized pipes.

Typically, bracings 10ab may be formed of metal but other materials may be used. Of course, bracings 10ab may take other shapes, such as, for example, a plate 500 with just one segment 510 extending substantially perpendicular from the plate 500. Bracings 10ab may be secured to members 100a,100b,100c,100d using various types of fasteners, such as screws, bolts, or pins. Also, bracings 10ab may be secured to one another using various types of fasteners, such as screws, bolts, or pins.

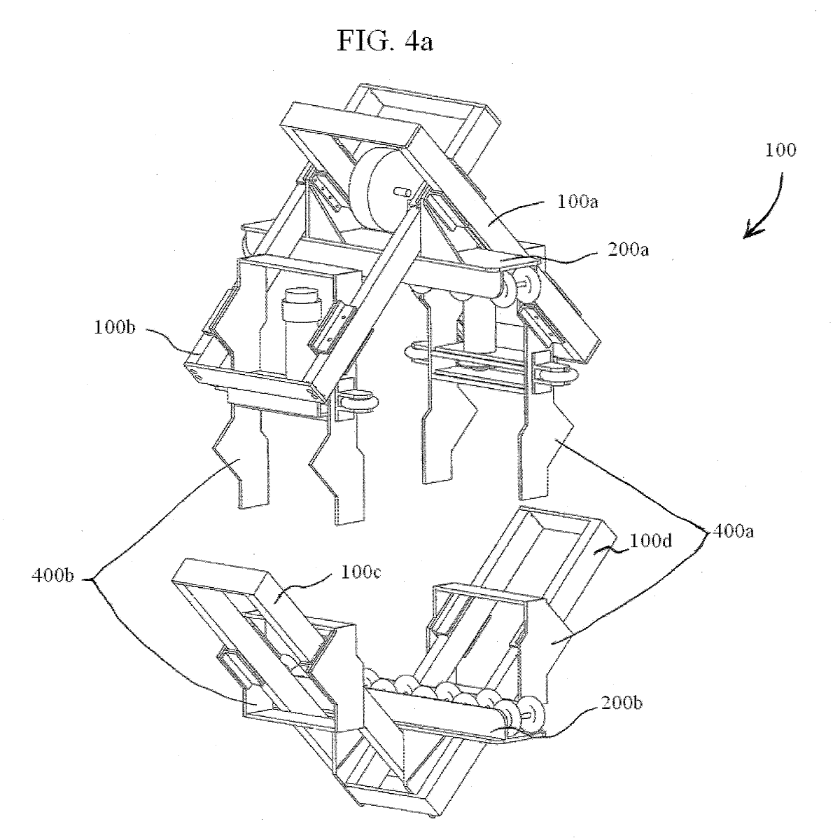

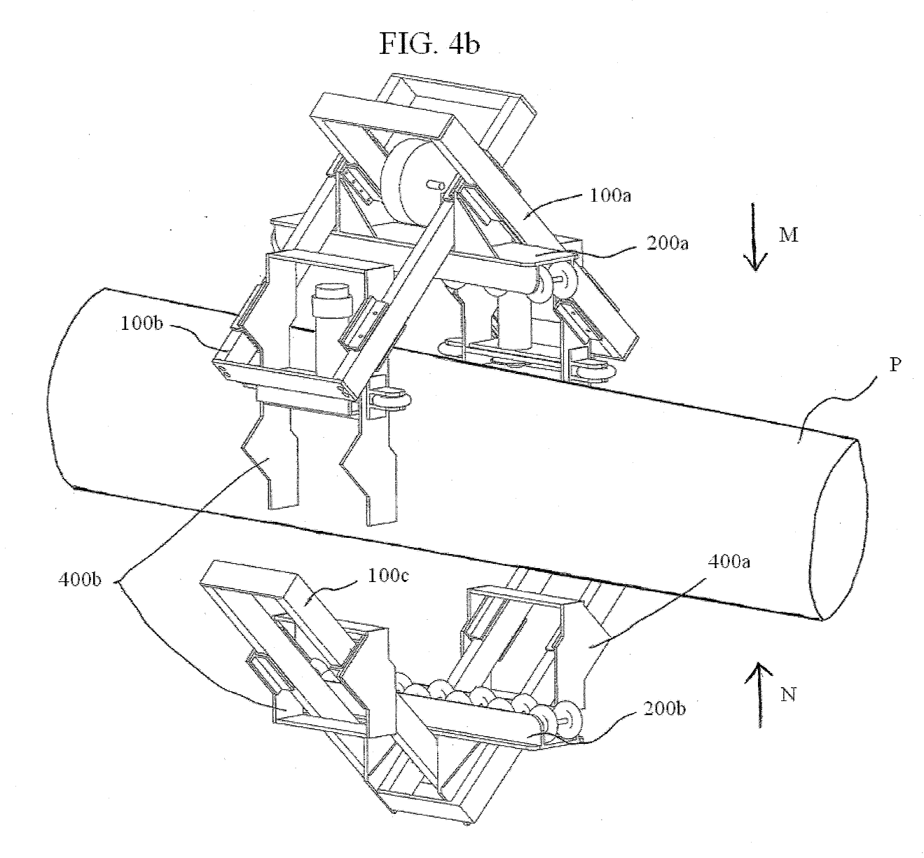

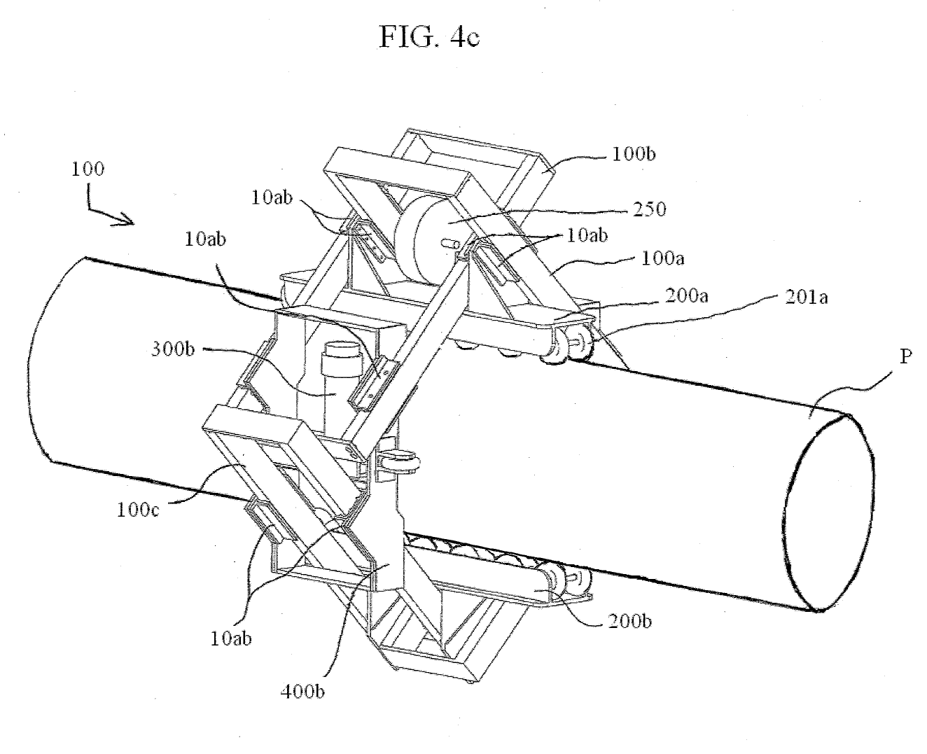

As shown in FIG. 1, members 100b and 100c may be secured to each other through a support structure 400b that is attached to members 100b,100c using bracings 10ab. Bracings 10ab may be secured to both the support structure 400b and members 100b,100c using various types of fasteners, such as screws, bolts, or pins. Alternatively, bracings 10ab may be integrated with the support structure 400b. Accordingly, members 100a,100b,100c,100d of the frame may be secured to each other indirectly using fasteners and bracings 10ab or a combination of fasteners, bracings 10ab, and support structures 400a,400b. As shown in FIG. 4a, a first v-shaped structure is formed by attaching members 100a,100b together, and a second v-shaped structure is formed by attaching members 100c,100d together. FIG. 4a also shows the drive system and cutting system attached to members 100a,100b,100c,100d. In particular, FIG. 4a shows support structures 400a, 400b broken into two parts. FIG. 4b shows the arrangement of parts of tool 100 of FIG. 4a positioned proximate a pipe P. As described further below, the first and second v-shaped structures may be moved along arrows M,N respectively such that the separate parts of support structures 400a,400b mate and can be attached to form tool 100. FIG. 4c shows the tool 100 attached to pipe P. When the tool 100 is attached to a pipe P, the two parts of the respective support structure are fastened together, such as by using nuts and bolts, adhesive, and the like. Of course, the members 100a,100b,100c,100d of the frame may be secured directly to each other using only fasteners.

The members 100a,100b,100c,100d of the frame may be formed of various materials, such as metal, wood, and the like. Typically, the members 100a,100b,100c,100d of the frame include strong, durable materials so as to withstand the loads required for securing the tool 100 to pipes P and the tough environments where pipelines P are often located. The adjustable cutting tool 100 of the present disclosure also includes a drive system.

The drive system is configured to move the tool 100 along a pipe P, such as, for example, the longitudinal axis of a pipe P. The drive system may typically include a drive motor 250 and wheels 201a,201b, which are driven by a drive chain (not shown) that connects the drive motor to at least one axle of the wheels. In FIG. 1, there are two sets of wheels. A first set of wheels 201a is shown housed in housing 200a, while a second set of wheels 201b is shown housed in housing 200b. The housings 200a,200b may be attached to the frame directly or indirectly. In FIG. 1, the housings 200a,200b are attached to the frame via fasteners and bracings 10ab. As shown in FIG. 3, the bracings 10ab and corresponding fasteners hold members 100a,100b of the frame together and also secure housing 200a to the frame. As shown in FIG. 1, the wheels 201a,201b contained within housings 200a,200b are configured to extend inward toward the open section of the frame. When the tool 100 is attached to a pipe P, the wheels 201a,201b of the drive system may be configured to contact the outer surface of the pipe P and provide a way of moving the tool 100 along the surface of the pipe P.

FIG. 1 shows a drive motor 250 adjacent to housing 200a and within the open sections of members 100a,100b. Typically, only one set of wheels 201a,201b would be powered by a drive motor 250. In one exemplary embodiment, drive motor 250 directly powers only the first set of wheels 201a. However, multiple sets of wheels may be powered by the same drive motor 250 or two sets of wheels 201a,201b may be powered by separate drive motors 250. When a drive motor 250 is activated, a drive chain that is operably connected to the drive motor 250 may begin to move causing the axles to rotate and the wheels 201a,201b to turn. As the wheels 201a,201b turn, the tool 100 may be propelled along the surface of the pipe P, such as, for example, along the longitudinal axis of the pipe P.

Any type of drive motor 250 may be used that can produce enough torque to move the tool 100 along the surface of a pipe P. The drive motor 250 may be pneumatic, gas-powered, or the like. Also, the wheels 201a,201b may be formed of various materials, including rubber, polyurethane, and other materials that are configured to engage and grip the surface of a pipe P. Generally, the wheels 201a,201b may be strong and durable to withstand the weight of a tool 100 and the conditions that a tool 100 may encounter. It should be noted that a tool 100 may also include a fuel tank, power supply, power cables, air compressor, and/or other accessories that the drive system and cutting system may utilize. The fuel tank, power supply, or other accessory may be attached to the frame or other portion of the tool 100 such that it moves with the tool 100. Alternatively, the fuel tank, power supply, air compressor, and/or other accessory may be separate from or remote relative to the frame, drive system, and cutting system.

The adjustable cutting tool 100 of the present disclosure also includes a cutting system. The cutting system may be configured to cut into pipe walls. The cutting system may include one or more cutting motors 300a, 300b and one ore more cutting blades 350a. As shown in FIG. 1, cutting motors 300a,300b may be attached to respective support structures 400a,400b. As noted above, support structures 400a,400b may be configured to at least secure members 100a,100b,100c,100d together to form the frame. It should be noted that more than one cutting motor 300a,300b may be attached to a single support structure 400a,400b such that cutting motors 300a,300b and cutting blades 350a sit adjacent to each other on the same support structure 400a,400b. Support structures 400a,400b may also be configured to support cutting motors 300a,300b and cutting blades 350a in a particular orientation. As shown in FIG. 1, a cutting blade 350a may be connected to a cutting motor 300a and extend at least partially out from the support structure 400a and into the open section of the frame. In FIG. 1, the support structure 400a maintains the cutting blade 350a and cutting motor 300a in a certain orientation. As mentioned above, it is appreciated that multiple cutting blades 350a and cutting motors 300a may be oriented on a support structure 400a. In particular, the orientation of the cutting system is such that as the tool 100 moves along the longitudinal axis of a pipe P, one or more cutting blades 350a will cut along a line that is parallel to the longitudinal axis of the pipe P.

The cutting motor 300a,300b may be any type of device that can rotate a cutting blade 350a at such a rate where the cutting blade 350a can cut into the surface of a pipe P. The cutting motor 300a,300b may include pneumatics, be gas powered, or the like. The cutting blade 350a may include a disk with serrated edges but may be other configurations. The cutting blade 350a may be formed of metal, carbon, or other materials and be various sizes. The type of cutting blade 350a and the type of cutting motor 300a,300b to be used may depend on the wall thickness of a pipe P. That is, a cutting blade 350a with a large radius may be needed to cut through a relatively thick pipe P wall while a cutting blade 350a with a smaller radius may be sufficient for a relatively thin pipe P wall. Similarly, a thicker pipe P wall may require a more powerful cutting motor 300a,300b. The type of cutting blade 350a and the type of cutting motor 300a,300b to be used may also depend on the material that forms the pipe. For example, a harder, denser pipe material may require a stronger, thicker cutting blade 350a and a more powerful cutting blade 300a,300b.

One or more cutting blades 350a,350b and/or cutting motors 300a,300b may be movable relative to the support structures 400a,400b, frame, and/or pipe P such that the distance in which the one or more cutting blades 350a,350b extends into the open section of the frame may be adjusted. For example, a support structure 400a,400b may be configured to move a cutting blade 350a and cutting motor 300a,300b into the open section of a frame. After the tool 100 is attached to a pipe P, the cutting blade 350a can be brought into contact with the surface of the pipe P. The cutting blade 350a may then continue to be moved along a line transverse to the longitudinal axis of the pipe P as the cutting blade 350a cuts the pipe P to the desired depth, such as through the wall of the pipe P. After the cutting blade 350a cuts its way to a desired depth into the pipe P, the cutting blade 350a may be locked into position so that the tool 100 cuts at this desired depth as it moves along the pipe P. As shown in FIG. 1, a second cutting motor 300b and corresponding cutting blade (not shown) may be positioned on the opposing side of the frame from the first cutting motor 300a and corresponding blade 350a. By having this dual cutting system, a pipe P may be cut along two sides simultaneously. One or more circumferential cuts may optionally be made to connect the two parallel cuts in order to allow a segment of the pipe P to be removed.

The cutting tool 100 according to an embodiment of the present disclosure may also include a cooling mechanism (not shown) for dispensing a cooling fluid. The fluid may be sprayed or otherwise deposited on the cutting blade 350a. In addition to cooling, the fluid may also reduce the chance of a spark being produced as the cutting blade 350a cuts into the wall of the pipe P.

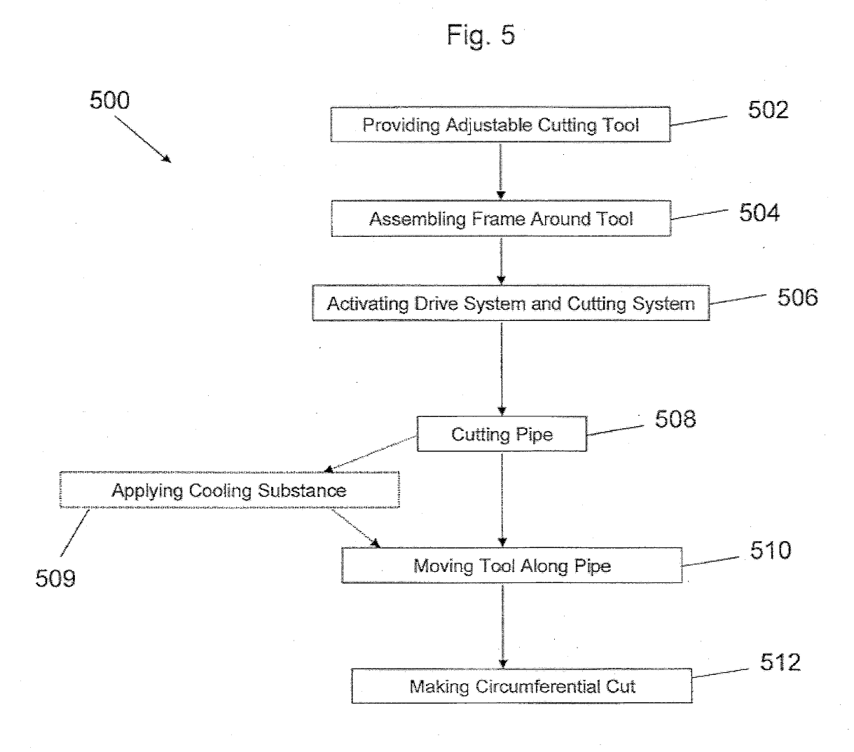

A typical example of using the adjustable cutting tool 100 of the present disclosure to cut pipeline is in the removal of pipeline casing. As described previously, some pipelines have a casing pipe that protects a carrier pipe. For the purposes of system inspection and maintenance, the casing pipes sometimes need to be removed. In such cases, the present disclosure may be used to cut off the casing from the pipeline. FIG. 5 shows one embodiment of the method for cutting through a casing wall of a pipe 500. First, an adjustable cutting tool may be provided 502. Next, the frame of the tool may be at least partially formed 504. In a four member frame, a first v-shaped structure may be formed by attaching two members together, and a second v-shaped structure may be formed by attaching the other two members together. FIG. 4 shows first and second v-shaped structures, which also include the drive system and cutting system. Then, the first v-shaped structure may be positioned underneath the pipe such that the pipe passes through the open section of the v-shape. The second v-shaped structure may be positioned on top of the pipe such that it straddles the pipe. The first and second v-shaped structures may then be secured to each other to form a square-diamond shape. In one exemplary embodiment, the support structures 400a,400b may serve to connect the two v-shaped structures. If not already attached to the frame, the drive system and cutting system may then be connected to the frame. Laser devices may be utilized to align the frame and other parts of the tool onto the pipe. Of course, other ways of aligning the tool may be used.

The next step of the method 500 may include activating the drive and cutting systems 506. The step of activating the drive and cutting systems 506 may include starting at least one of the drive motor or cutting motor and/or moving a cutting blade at least partially into the open section of the frame towards the pipe. The cutting blades may be put in contact with surfaces of the casing. Then, the cutting blades may proceed to cut through the wall of the casing 508. Optionally, a cooling substance may be applied to the cutting blades as the blades proceed to cut through the wall of the casing 509. As each cutting blade cuts through at least a portion of the wall of the casing, the drive motor may be operated to cause the drive chain to move and the wheels to turn. Consequently, the tool may move along the surface of the pipe 510. As the tool moves along the pipeline via the drive system, the cutting blades continue to cut through portions of the wall of the casing. Upon cutting the desired length of casing, the drive motor may be deactivated causing the drive chain and wheels to stop moving. The cutting blades may then be moved away from the pipe and the cutting system turned off. The drive and cutting systems may then be removed, followed by removal of the frame. Alternatively, the frame may be disassembled with the drive and cutting systems attached. The pipeline casing now has two continuous cuts running parallel with the longitudinal axis of the pipeline. Optionally, one or more circumferential cuts may be made on the casing to connect the longitudinal cuts made by the tool 512 to facilitate removal of a portion of the pipeline casing.

It should be noted that while a pipeline casing was used in the example above, any type of pipe may be used. In other words, the tool 100 and method discussed above may be applied to a bare or carrier pipe, not just a pipeline casing. Therefore, a carrier pipe may be cut by a tool 100 in the same or similar manner as a pipeline casing.

While this disclosure has been described with reference to particular embodiments, the apparatus and methods according to the present disclosure can be further modified within the scope and spirit of this disclosure. This application is therefore intended to cover any variations, uses, or adaptations of the disclosure using its general principles. Furthermore, this application is intended to cover such departures from the present disclosure as come within known or customary practice in the art to which this disclosure pertains.

What is claimed is:

1. An adjustable cutting tool for cutting through the wall of a pipe, comprising:
a frame comprising a plurality of members connected to form a shape with an open section, wherein the open section of the frame is configured to receive a pipe and wherein the plurality of members are configured to be adjusted relative to each other such that the cross-sectional area of the open section of the frame is variable;
a drive system attached to the frame and configured to move the tool along the surface of the pipe, the drive system comprising a drive motor, a plurality of wheels, and a drive chain that connects the drive motor to the plurality of wheels, wherein at least one of the plurality of wheels is configured to be rotated by the drive chain; and
a cutting system attached to the frame, the cutting system comprising at least one cutting motor and at least one cutting blade, wherein the at least one cutting motor is configured to rotate the at least one cutting blade and the at least one cutting blade is configured to at least partially extend into the open section of the frame.

2. The adjustable cutting tool of claim 1, wherein the plurality of members comprises four rectangular-shaped parts having open sections.

3. The adjustable cutting tool of claim 1, wherein the shape of the frame comprises a substantially square-diamond shape.

4. The adjustable cutting tool of claim 1, wherein the cutting system further comprises at least one support structure configured to attach to the frame and support the at least one cutting motor and the at least one cutting blade.

5. The adjustable cutting tool of claim 4, wherein the at least one support structure at least partially secures two members of the frame together.

6. The adjustable cutting tool of claim 1, wherein the at least one cutting motor comprises a pneumatic system.

7. The adjustable cutting tool of claim 1, wherein at least two cutting blades are positioned on opposing sides of the frame.

8. The adjustable cutting tool of claim 1, wherein the drive motor comprises a pneumatic system.

9. An adjustable cutting tool for cutting through the wall of a pipe, comprising:
a frame comprising four members connected to form a substantially square-diamond shape with an open section, wherein the open section of the frame is configured to receive a pipe and wherein the plurality of members are configured to be adjusted relative to each other such that the cross-sectional area of the open section of the frame is variable;
a drive system attached to the frame and configured to move the tool along the surface of the pipe, the drive system comprising two drive motors, two sets of wheels, and two drive chains that each connect one of the two drive motors to one of the two sets of wheels such that each drive motor can rotate the corresponding set of wheels; and
a cutting system attached to the frame comprising at least one cutting motor and at least one cutting blade, wherein the at least one cutting motor is configured to rotate the at least one cutting blade and the at least one cutting blade is configured to at least partially extend into the open section of the frame.

10. The adjustable cutting tool of claim 9, wherein the four members comprises rectangular-shaped parts having open sections.

11. The adjustable cutting tool of claim 9, wherein the at least one cutting motor comprises a pneumatic system.

12. The adjustable cutting tool of claim 9, wherein at least two cutting blades are positioned on opposing sides of the frame.

13. The adjustable cutting tool of claim 9, wherein the drive motor comprises a pneumatic system.

14. A method of cutting through the casing wall of a pipe using an adjustable cutting tool, comprising:
providing an adjustable cutting tool comprising:
a frame comprising a plurality of members configured to be connected to form a substantially square-diamond shape with an open section, wherein the open section of the frame is configured to receive a pipe;
a drive system attached to the frame and configured to move the tool along the surface of the pipe, the drive system comprising a drive motor, a plurality of wheels, and a drive chain that connects the drive motor to the plurality of wheels, wherein the plurality of wheels are configured to be rotated by the drive chain; and
a cutting system attached to the frame comprising at least one cutting motor and at least one cutting blade, wherein the at least one cutting motor is configured to rotate the at least one cutting blade;
assembling the frame of the tool around a pipe;
activating the drive system and the cutting system of the tool;
cutting the pipe using the at least one cutting blade of the cutting system of the tool; and
moving the tool along the pipe using the drive system.

15. The method of cutting of claim 14, wherein assembling the frame of the tool around a pipe comprises forming two substantially V-shaped structures using the plurality of members and securing the V-shaped structures together to define the frame about the pipe.

16. The method of cutting of claim 14, wherein activating the drive system and the cutting system of the tool comprises moving the at least one cutting blade towards the open section of the frame.

17. The method of cutting of claim 14, wherein cutting the pipe comprises making two cuts that are parallel with the longitudinal axis of the pipe.

18. The method of cutting of claim 17, further comprising making at least one circumferential cut to at least connect the two cuts that are parallel with the longitudinal axis of the pipe.

19. The method of cutting of claim 18, wherein activating the drive system and the cutting system comprises starting at least one of the drive motor or cutting motor.

20. The method of cutting of claim 14, further comprising applying a cooling substance to at least a portion of the cutting system.
